(19) United States
(12) Patent Application Publication
(10) Pub. No.: US 2015/0250134 A1
(43) Pub. Date: Sep. 10, 2015

(54) CLOSED SYSTEM VIVARIUM FOR USE WITH AN AQUARIUM

(71) Applicant: Howard E. Hicks, St. Paul, MN (US)

(72) Inventor: Howard E. Hicks, St. Paul, MN (US)

(21) Appl. No.: 14/200,275

(22) Filed: Mar. 7, 2014

(51) Int. Cl. A01K 1/03; A01K 63/06; A01K 63/00

(52) U.S. Cl. CPC A01K 1/03; A01K 63/006; A01K 63/06

(57) ABSTRACT

A vivarium system for use with an aquarium is described. A closed container adapted to fit on an aquarium with a hole in the bottom planar member of the vivarium allows animal access from the vivarium into the aquarium underneath when used in conjunction with an aquarium. The container may be provided with condensation control and/or lights. In some embodiments the vivarium further comprises stands to assist in the animal transition between the aquarium and the vivarium. In further embodiments the vivarium/aquarium assembly is connected to a tidal flow control mechanism, which allows for the cyclical raising and lowering of the water level in the aquarium.

### TECHNICAL FIELD

The technical field is generally directed to an apparatus for the containment of animals and its use, for example in-home vivariums.

### BACKGROUND OF THE INVENTION

Aquariums provide an artificial aquatic environment. Vivariums provide an artificial terrestrial and/or aquatic environment. In nature, amphibious animals are capable of inhabiting both aquatic and terrestrial environments.

### SUMMARY OF THE INVENTION

The goal of a vivarium or aquarium is to provide a suitable habitat for the animals contained within them. Currently, when a dual environment (land and water) is desired in an aquarium a low level of water is used in the aquarium. The reduced volume and depth of the water limits the types of species that can be accommodated in the water environment. Similarly, the limited land area limits the species that can be accommodated on the land. Often these limitations lead to using the aquarium and vivarium combination for just aquatic or just terrestrial species, with the additional environment being used for plants or as a water source. Alternatively, the aquarium is divided vertically into independent compartments with one side acting as an aquarium and the other acting as a vivarium. In this assembly, no interaction between the environments is possible. None of the described assemblies are suitable for use with aquatic, terrestrial, and amphibious animals.

An embodiment of the invention is a vivarium system for use with an aquarium to allow an animal to readily move between a water environment and an earth environment comprising a closed container that communicates with ambient air through a filter. The container comprises a bottom planar member adapted to fit on top of an aquarium with a hole in the bottom planar member to provide animal access to an aquarium under the container when the container is positioned over an aquarium.

An additional embodiment is a method for using a vivarium system comprising placing a closed container with a bottom planar member adapted to fit on an aquarium on the aquarium with the bottom planar member resting on the aquarium. The closed container communicates with ambient air through a filtered opening that comprises a filter with a pore size of no more than about 2 mm and the bottom planar member further comprises a hole providing animal access to the aquarium.

### BRIEF DESCRIPTION OF THE DRAWINGS

FIG. 1 is a front perspective view of an embodiment of the invention.

FIG. 2 is a side view of the embodiment of FIG. 1.

FIG. 3 is a perspective view of an embodiment of the invention with the removable viewing section removed.

FIG. 4 is a partial sectional view of an embodiment of the invention with the viewing section cut away.

FIG. 5 is a rear perspective view of the embodiment of FIG. 4.

FIG. 6 is a front perspective view of an embodiment of the invention with the removable top removed.

FIG. 7A is a front perspective view of one possible shape of a container.

FIG. 7B is a front perspective view of one possible shape of a container.

FIG. 7C is a front perspective view of one possible shape of a container.

FIG. 7D is a front perspective view of one possible shape of a container.

FIG. 8 is a perspective view of a stand.

FIG. 9 is a perspective view of a vivarium system with an associated aquarium and tidal flow control mechanism with the removable viewing section removed.

### DETAILED DESCRIPTION OF THE INVENTION

It is desirable to create an artificial environment that allows many different types of animals to exist in their preferred habitats. Aquatic, terrestrial, and amphibious animals all require different environments to survive and thrive as pets, but current vivarium/aquarium assemblies provide only restricted space for the different habitats. This limits the interaction of the animals, reduces the space available to the particular habitats, and limits the possibilities to mimic the natural ecosystems. Set forth herein, however, is a vivarium system that allows animals, especially amphibious animals, to transition between various full-sized habitats without escaping.

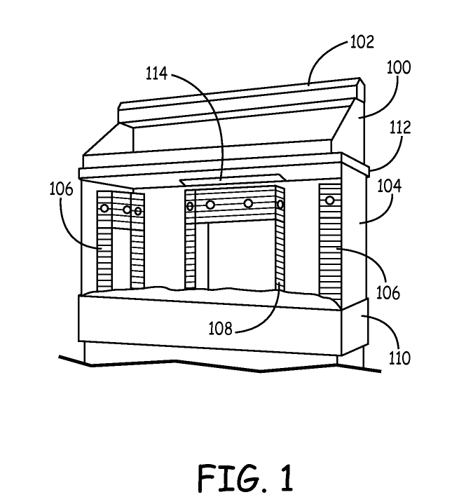

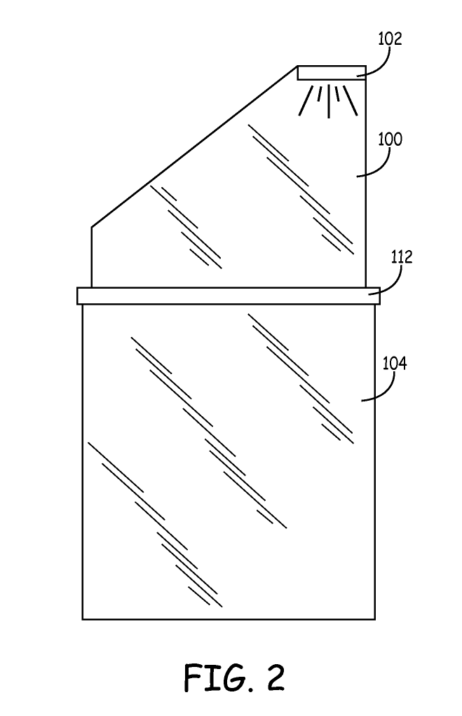

An embodiment of a vivarium system and an aquarium assembly is depicted in FIGS. 1-2. Closed container 100 rests on upper rim 112 of aquarium 104. Closed container 100 is slightly smaller than the top of aquarium 104, allowing container 100 to rest on the lip of upper rim 112 slightly inside aquarium 104. Aquarium 104 sits on furniture stand 110. Back stand 108 rests on the floor of aquarium 102 in the center rear portion of aquarium 102. Side stands 106 rest on the floor of aquarium 104 along either side. Light 102 rests on the top portion of container 100 oriented to provide light to container 100. Container 100 has hole 114 in the bottom of container 100. Back stand 108 is positioned under hole 114.

In use the vivarium is placed on aquarium 104 with hole 114 in the bottom of container 100 positioned over optional back stand 108. Back stand 108 may be positioned as desired. The vivarium is filled with rocks or sand, terrestrial plants, and animals. Aquarium 104 is filled with water, fish, and other aquatic plants and animals. The platform portion of stand 110 is optionally filled with rocks or sand and plants. Animals transition between the vivarium and the aquarium portions of the assembly. Light 102 provides light and heat to the assembly.

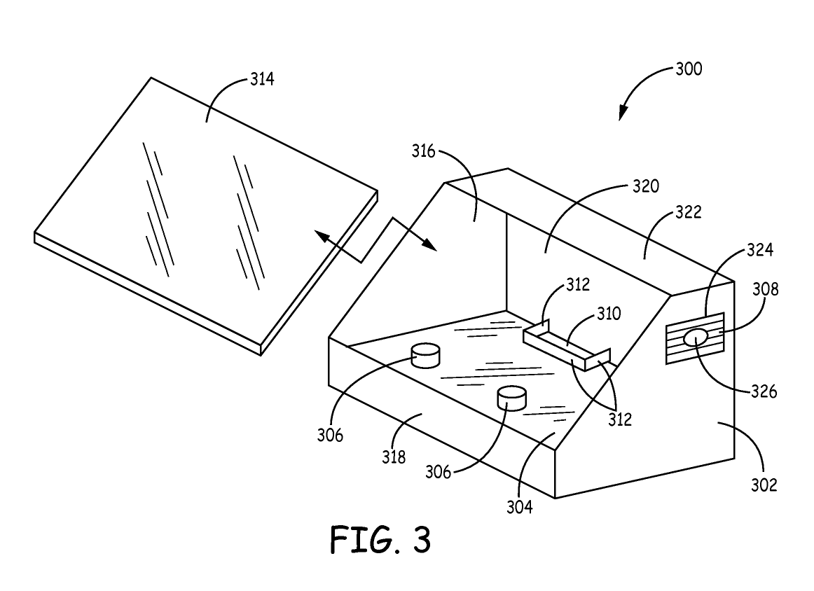

FIG. 3 depicts an alternative embodiment of the invention. Closed container 300 has front wall 318, back wall 320, side wall 302 with a condensation control system 326, and side wall 316. Walls 302, 316, 318, 320 are attached to bottom 304 and together completely bound bottom 304. Container 300 also has top 322 attached to side walls 302, 316, and back wall 320. Transparent viewing section 314 is reversibly removable from container 300. In place on container 300, section 314 sealingly fits with side walls 302, 316, the front wall 318, and the top 322. Hole 310 in bottom 304 is positioned so that back wall 320 forms one boundary of hole 310. Short barriers 312 in combination with back wall 320 surround hole 310. Lights 306 rest on bottom 304 and are oriented to shine through bottom 304 into an aquarium that would be positioned underneath when the vivarium is used in a vivarium/aquarium assembly. All or a portion of bottom 304 may be transparent to accommodate lights 306. Condensation control system 326 has a fan attached to side wall 302 placed in opening 324 to force ambient air into, or out of, container 300 through filter 308 in opening 324.

In use, light 306 provides light to the aquarium underneath the vivarium, when used in a vivarium/aquarium assembly. Transparent viewing section 314 is placed on container 300, closing container 300. The area inside the vivarium is visible through transparent viewing section 314. Short barriers 312 around hole 310 prevent rocks or sand from falling through hole 310. Short barriers 312 may also act as a deterrent for terrestrial animals attempting to enter hole 310. Condensation control system 326 reduces condensation on a viewing section by forcing the exchange of less humid ambient air with the air in the vivarium.

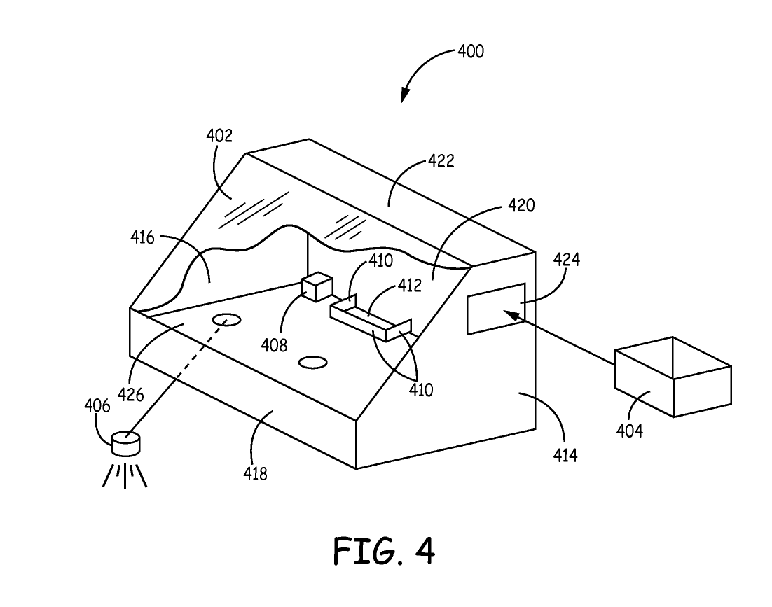

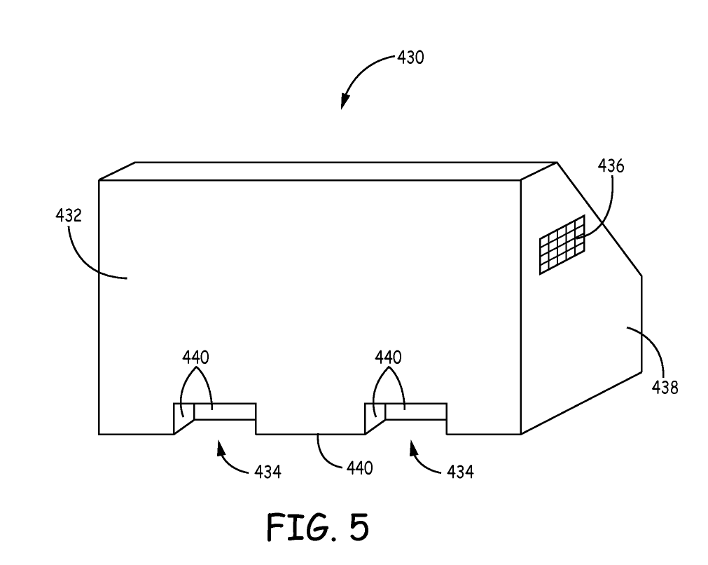

FIG. 4 depicts another alternative embodiment of the vivarium. In FIG. 4 container 400 has front wall 418, back wall 420, side wall 414 with tray opening 424, and side wall 416 that are attached to and completely enclose bottom 426. Container 400 also has top 422 attached to side walls 414, 416, and back wall 420. Transparent viewing section 402 is removably attached to side walls 414, 416, front wall 418, and top 422 at a diagonal. Hole 412 in bottom 426 is positioned so that back wall 420 forms one boundary of hole 412. Short barriers 410 surround hole 414. Lights 406 are attached to the underside of bottom 426 oriented to shine into an aquarium underneath when the vivarium is used in a vivarium/aquarium assembly. Back wall 420 and bottom 426 contain block shaped recessed cutouts 408 for access to an aquarium when the vivarium is used in a vivarium/aquarium assembly. Side wall 414 contains tray opening 424 where removable feed tray 404 is inserted. When feed tray 404 is in place, tray opening 424 is sealed and animals cannot escape container 400 through tray opening 424. Removable feed tray 404 is a rectangular box without a top. FIG. 5 depicts the back view of container 430. Side wall 438 has a filtered vent 436 for condensation control. Back wall 432 and bottom 440 contain recessed cutouts 434 to allow access into the aquarium when the vivarium is used in a vivarium/aquarium assembly. Recessed cutouts 434 contain walls 440 and a top (not pictured) that effectively seal cutouts 434 off from container 430.

In use, container 400, 430 is placed on top of an aquarium and recessed cutouts 408, 434 create a gap that serves as an access between container 400, 430 and the walls of the aquarium. This access allows hoses, nets, plants, animals, and food to the aquarium. Removable feeding tray 404 is filled with food for the animals in the vivarium and inserted into tray opening 424. Filtered vent 436 controls condensation by allowing passive communication between the ambient air and the air inside the vivarium.

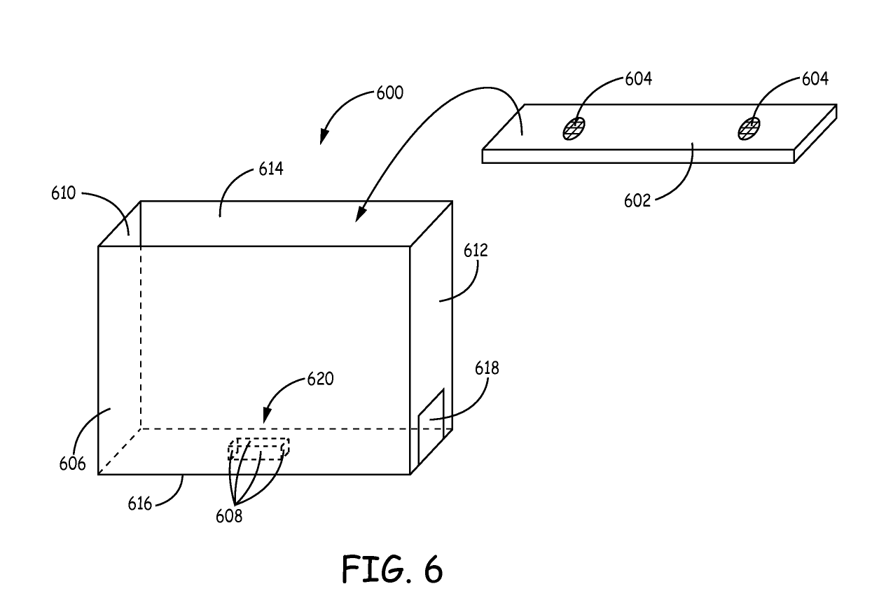

FIG. 6 depicts box-like container 600 with top 602 removed. Bottom 616 is enclosed by front transparent viewing section 606, side walls 610, 612, and back wall 614. Walls 606, 610, 612, 614 are attached to bottom 616. Hole 620 in bottom 616 is located near the center of bottom 616 and is surrounded by short barriers 608 that are attached to bottom 616. Side wall 612 contains resealable opening 618 for access into container 600. Top 602 contains vents 604 covered with a filter for condensation control. When in place, top 602 is removably attached to side walls 610, 612, front viewing section 606, and back wall 614.

In use, resealable opening 618 is opened and closed to provide access to the interior of the vivarium. Top 602 is placed on container 600 and closes container 600. Filtered vents 604 provide condensation control by allowing the passive communication between ambient air and air inside the vivarium.

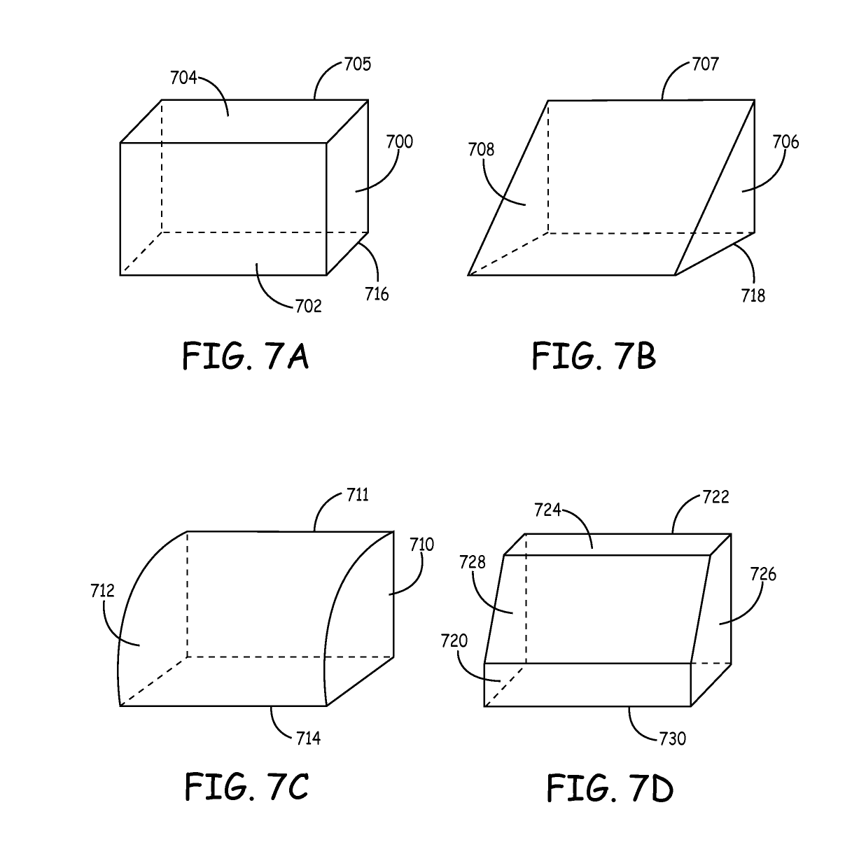

FIGS. 7A-7D depict some examples of the basic shapes the container may take. FIG. 7A depicts a rectangular container with front wall 702, back wall 705, and side walls 700, attached to bottom 716 on one end and top 704 on the other. Walls 700, 702, 705 completely enclose bottom 716. FIG. 7B depicts a prism shaped container. The container has front panel 708, two side walls 706, back wall 707, and bottom 718. Front panel 708 is connected to back wall 707, side walls 706, and bottom 718. FIG. 7C depicts a quarter cylinder shaped container. The container has curved front panel 712, bottom 714, two side walls 710, and back wall 711. The front panel 712, is connected to back wall 711, side walls 706, and bottom, 718. FIG. 7D depicts a container with front wall 720, two side walls 726, back wall 722, top planar member 724, bottom 730, and front viewing panel 728. Walls 726, 722, 720 completely enclose bottom 730. Front viewing panel 728 is attached to side walls 726, front wall 720, and top planar member 724. Top planar member is attached to side walls 726 and back wall 722. In use a wall, part of a wall, or various walls comprise transparent viewing sections.

The vivarium includes a closed container that further comprises a hole in the bottom that serves as an ingress/egress for animals between the vivarium and a container under the vivarium, which is typically an aquarium. The term closed means substantially water tight, recognizing that vivariums and the like are not customarily perfectly sealed. The container is designed to sit on top of an aquarium, substantially covering the top of the aquarium.

In an embodiment, when a closed container is placed over an aquarium, animals as small as a fruit fly cannot escape the vivarium/aquarium assembly. Fruit flies are generally about 1 mm to about 3 mm in length and about 1 mm to about 2 mm in width. When the container is closed it prevents animals, especially flying or climbing insects, from escaping the assembly. In additional embodiments, larger animals are unable to escape the assembly.

An advantage of the vivarium is that its enclosed environment allows for establishment of an ecosystem. In nature, smaller animals are often food for larger animals. Closed containers keep these small, quickly reproducing animals, like fruit flies, in the vivarium. These animals may provide a long term food source without needing to add food to the vivarium. In a traditional vivarium or aquarium, these smaller animals can escape and, instead of having a local ecosystem that includes a food chain, users must add food from outside the vivarium and/or aquarium.

In general, the container rests on a bottom. A hole in the bottom allows access to the underlying aquarium or other container. The underside of the bottom, which is oriented toward the underlying aquarium or other container, may be free of projections. Sides are attached to the outer edges of the bottom. Some embodiments contain a top, which is attached to the sides opposite the bottom. In further embodiments a side comprises a diagonal portion. A diagonal portion refers to a surface which forms an angle of about 10 degrees to about 80 degrees between the surface and the bottom of the container. The diagonal portion may intersect the bottom of the container, or it may be an extension of a side surrounding the bottom, and the diagonal surface may additionally intersect the top. A side may be entirely a diagonal portion. In some embodiments the diagonal surface is at an angle between about 10 degrees to about 80 degrees. In further embodiments the diagonal surface may be at an angle between about 15 degrees and about 70 degrees, about 20 degrees and about 60 degrees, or about 25 degrees and about 50 degrees. A person of ordinary sill in the art will recognize that additional ranges are contemplated and are within the present disclosure. Artisans will immediately appreciate that all values and ranges within the expressly stated limits are contemplated, e.g., about.

The bottom of the container generally has dimensions similar to the top of the aquarium. In some embodiments the bottom of the container is slightly smaller than the top of the aquarium so that it can sit partially inside the aquarium, resting on the lip of the upper rim. The bottom of the container may optionally comprise flanges that rest on the aquarium top edge and/or fit over the side of the aquarium. In some embodiments the bottom of the container is slightly larger than the top of the aquarium so that the vivarium can sit directly on top of the aquarium. In some embodiments the sides of the container extend past the bottom of the container so that the container fits over the aquarium and cannot shift horizontally. The container may rest, unattached, on the aquarium or it may be attached with an adhesive, sealant, screws, or braces.

In one embodiment the bottom of the container is slightly smaller than the top of the aquarium and the container rests on the lip of the upper rim. The upper portion of the container may take a number of shapes, for example, box, prismatic, polygonal, cylindrical, and dome. In some embodiments the bottom is substantially planar.

The container in whole or in part may be made of a material suitable for creating a closed container, for example, plastic, acrylic, glass, plastic sheeting, fine mesh, metal, treated wood, or a combination of these or other suitable materials. In one embodiment at least three surfaces of the container are made of clear acrylic. In further embodiments all surfaces are made of clear acrylic. The container may be molded from a single piece of material or may be made from separate pieces that are assembled prior to use.

The container comprises at least one viewing section that is made of an optically clear material. It may be, for example, a front wall, as in an aquarium, a top panel, a diagonal portion of a side, or a portion thereof. The container may also comprise a lid or top to close the container. The lid, top, or viewing section may be removable, allowing for cleaning and maintenance of the interior of the container. The viewing section, lid, or top may be removably attached to the container by adhesive (e.g. glue or tape), hinges, rubber or plastic seals, friction fit, interlocking flanges or other known methods. Alternatively, it may be sized to fit over the container, creating a seal. The viewing section, lid, or top may be made of a number of materials, for example, plastic, acrylic, glass, disposable plastic sheeting, fine mesh, metal, or treated wood. Optically clear materials include, for example, clear plastic, acrylic, glass, or disposable plastic sheeting. In one embodiment, the viewing section is a diagonal portion of a side made of removable plastic sheeting. In addition to the viewing section, the additional surfaces of the container may be partially or completely optically transparent.

The bottom has one or more holes sized large enough to allow animals passage from the container into the aquarium. The hole may be a shape appropriate for the ingress or egress of animals, for example, square, rectangular, oval, or circular. The hole may be a size appropriate for the ingress or egress of animals, for example, the area encompassed by the hole may be at least about 16 in², at least about 30 in², at least about 36 in². In some embodiments the area encompassed by the hole may be from about 16 in² to about 40 in², from about 20 in² to about 36 in², or from about 25 in² to about 36 in². A person of ordinary sill in the art will recognize that additional ranges are contemplated and are within the present disclosure. Artisans will immediately appreciate that all values and ranges within the expressly stated limits are contemplated, e.g., about. The hole may be located at or near the center of the bottom, the hole may be located near the edge of the bottom, or the hole may be positioned so that at least part of the boundary of the hole is defined by a container wall. The holes may, but need not, be partially or fully surrounded by short barriers protruding from the bottom into the interior of the container. The term short barriers refer to walls protruding from the bottom of the vivarium into the container. In general, they are short enough to allow passage of animals between the top of the barrier and the top of the container and tall enough to prevent rocks, sand, and other materials from falling into the aquarium. In some embodiments the short bathers are at least about ¼ inch tall. In further embodiments the short barriers are at least about ¼ inch tall, about 1 inch, or about 2 inches tall. In additional embodiments, the short barriers are between about 0.25 inches and about 6 inches tall, between about 0.5 inches and about 4 inches tall, between about 0.5 inches and about 3 inches tall, or between about 0.5 inches and about 2 inches tall. The short barriers may be made of any suitable materials, for example, metal, plastic, or clear acrylic. In some embodiments the short barriers are made of the same material as the bottom of the container. The short barriers may be separate pieces attached to the bottom or the bottom and the short barriers may be molded as one piece. A person of ordinary sill in the art will recognize that additional ranges are contemplated and are within the present disclosure. Artisans will immediately appreciate that all values and ranges within the expressly stated limits are contemplated, e.g., about. The short barriers are designed to prevent rocks, sand, and other materials from falling into the aquarium. The short barriers also deter terrestrial animals from falling into the aquarium.

The vivarium may have one or more cutouts to allow for maintenance. The cutouts may be recesses in the container structure or resealable openings. Recess refers to a three dimensional void in the container shape that is sealed off from the inside of the container, e.g. FIG. 4 element 408 and FIG. 5 element 434. Recesses may be a suitable shape, for example, blocks, cubes, cylinders, pyramids, spheres, and spheroids. The recess is large enough to allow for hoses, animals, plants, nets, or food to be added to or removed from the aquarium. The recess may be positioned at a convenient or aesthetically pleasing area of the container. In one embodiment the recess is located the point where a wall meets the bottom of the container. When positioned in this way the recess creates a gap between the container and the aquarium. Aquariums and vivariums may require occasional maintenance including cleaning, feeding, the addition of animals or plants, and changing or adding water. This gap may then be used to access the aquarium under the vivarium without needing to move the vivarium.

Access to the container and/or aquarium may also be achieved by one or more resealable openings. A resalable opening may be in the surfaces of the container or the surfaces of a recess. Placement of resealable openings may be determined by ease of access or aesthetic purposes. Which portion of the aquarium/vivarium assembly is accessible is determined by the location of the resealable opening. Resealable openings may be placed in the walls, top, or viewing sections to allow for access into the vivarium. Resealable openings in the walls adjacent to the hole in the bottom allow access into the vivarium and the aquarium. Resealable openings in the bottom allow for access into the aquarium. Resealable openings in some embodiments are at or near an edge. Because the openings are for maintenance purposes, the resealable openings are large enough to allow for hoses, animals, plants, nets, or food to be added to or removed from the assembly as required. The resealable openings may be a shape appropriate for the intended use, for example, square, rectangular, or circular. Openings may be made resealable by an appropriate means, including, adhesive, Velcro, plastic or rubber seals, friction fit, hinges, or by making the cover slightly larger than the opening. When not in use, the resealable openings are closed and sealed, keeping the container closed. Similar to recesses, resealable openings allow for the addition or removal of food, plants, animals, or water into or out of the aquarium or vivarium.

The vivarium may optionally contain a removable feeding tray. In one embodiment the tray fits inside an opening in the container. The tray is moved to an open position to place food in the tray. The tray is moved to a closed position where the tray is inside the container. In the closed position, the tray sealingly fits with the container to provide a closed system. In another embodiment, the tray is placed into the container through a resealable opening. The resealable opening is then closed as discussed in detail above. In further embodiments the feeding tray comprises a divided rotating shelf structured like a revolving door. In these embodiments the divisions act to seal the opening after the tray has been rotated. The tray may rest on the bottom of the vivarium, on a free standing platform or other additional structure, may be hung from a wall or the top, may rest on a platform attached to a wall, or may fit into the opening in such a way that no additional support is required to keep the tray at a specific height above the bottom of the container. Additionally, or alternatively, the tray may comprise hooks that attach to the opening or to grooves in a wall. The feeding tray is a shape or size appropriate for the introduction of food or animals into the container. Examples include blocks, boxes, flat shelves, and drawers. The opening for the feeding tray may be resealable by an appropriate method, as described above, for example, adhesive, Velcro, hinges, oversizing of the cover, rubber or plastic seals, or friction fit. The feeding tray allows for the introduction of food into the vivarium with minimal opening of the container which minimizes the chance of escape of the animals inside the container.

Resealable openings are closed when not in use in order to keep the container close, but there may be occasions when it is preferable that the container remain in extended communication with the ambient environment. In these situations, a filter, sieve, or mesh may be required to maintain the closed condition of the container. The term filter is a broad term that is used to refer to an apparatus that is designed to allow communication between two environments while preventing the transfer of items of a particular size or larger. An appropriate filter may be made of suitable materials, e.g. plastic, nylon, silk, paper, metal, cellulose, ceramic, cotton, fabric, carbon, and polymer. The term pore size refers to the mean or median size of the individual holes in the filter, and indicates the largest size of a particle that will be generally able to pass through the filter. In some embodiments, filters will have a pore size of no more than about 2 mm. In other embodiments filters will have a pore size of no more than about 1.5 mm, no more than about 1 mm, or no more than about 0.5 mm. Alternatively, the maximum pore size may be selected to fall within a range from about 0.1 microns and about 5 mm. Artisans will immediately appreciate that all values and ranges within the expressly stated limits are contemplated, e.g., from about 1 micron to about 2 mm, or from about 0.5 mm to about 4 mm.

The vivarium may include a condensation control. The term condensation control refers to a device that has the ability to reduce and/or prevent condensation on at least a portion of the interior of the container. Condensation control may be passive and/or active. Active condensation control refers to a condensation control that requires prolonged mechanical and/or electrical intervention to work, for example, forced air flow, fans, vacuums, heaters, or heated glass. Passive condensation control refers to a form of condensation control that does not require prolonged intervention, for example, anti-fog coatings or diffusive air flow through openings.

In some embodiments, the condensation control is active. An active condensation control employed may be structured to prevent the escape of animals as small as fruit flies, e.g. with filters. Active condensation controls may be placed on the top or walls of the container. In one embodiment a fan is positioned on the side wall of the container directed toward the viewing section with a filter, so that when the fan is turned on air is directed across the viewing section, reducing the condensation. The air may flow into and/or out of the vivarium, depending on the configuration of the fan. The air may be heated. In additional embodiments, the condensation control system comprises heated air forced into the vivarium and/or across a viewing section. In further embodiments the condensation control system comprises heating elements embedded in a viewing section. The condensation control may also comprise forms of temperature control known in the art including heated air, heat lamps, and a heater for heating the viewing section. Active condensation control systems as well as temperature control systems may comprise switches, timers, or sensors to allow for individualized control. If multiple condensation control and/or heat control systems are used the systems may be controlled separately or in combination.

A passive condensation control may comprise vents or other openings to allow for communication of ambient air with the air inside the container, reducing the humidity. To insure the container remains closed, the vents may be fitted with a suitable filter as described above or other means for preventing the escape of animals from the vivarium. A vent may have an open position and a closed position. When in the open position the vent allows the diffusion of air into and out of the container. The vents may be positioned on the tops or walls of the container. Alternatively a wall or top of the vivarium may be made of a filter, allowing for passive condensation control. Passive condensation control may also be achieved by treating and/or coating a surface of the container to resist condensation. The treatment may be, for example, a coating solution or cleaning solution.

Because the closed container may be positioned over an aquarium, there exists the potential for high humidity to cause condensation on the surfaces of the container, hindering viewing. In order to allow for proper viewing of the inside of the container, as well as to maintain a desired level of humidity in the vivarium, some means for condensation control may be employed. The condensation control reduces the condensation. Less condensation improves viewing. Condensation control may be applied to reduce the condensation on the entire container or to a portion of a container that comprises a viewing section.

Lights may be provided in the container. The lights may be a form of lighting, for example, incandescent lights, florescent lights, light emitting diodes, and heat lamps. Lights may be placed on top, on a wall, on the bottom, or external to the vivarium. The placement of the lights may be based on their desired use. Lights may be placed in cutouts or recesses in a surface, top, bottom, or lid of the vivarium. The lights may be attached to the vivarium by a suitable means, for example, adhesive, friction fit, screws, or rubber or plastic seals. Where appropriate, the lights may also rest without attachment. The lighting system may additionally comprise switches, timers, or sensors to allow for individualized control. If multiple lights are used, each light may be controlled separately or in combination. The lights, their attachment points, and/or wiring or other electrical structures may be sealed to prevent water damage, to improve the attachment, or to prevent the escape of animals from the vivarium. Suitable sealants include rubber, plastic, or silicon.

Lights placed on top of the vivarium may be oriented so that the light shines into the vivarium. In some embodiments the light is placed on the outside of the vivarium, shining through an optically transparent top. In other embodiments the light is integrated with a lid. In still further embodiments the light is attached to the underside of a top. The lights may be attached or sealed as described above. Lights placed on top of the vivarium allow for the traditional means of lighting the vivarium.

Lights placed on the bottom of the vivarium may be oriented so that the light shines into the vivarium or may be oriented so that the light shines into the aquarium. When placed on the bottom, the lights may sit on the bottom of the container inside the vivarium, they may be set into recess or cutouts, or they may be attached to bottom of the container outside the vivarium. If the bottom is optically transparent, the light may shine through the bottom. In one embodiment the lights are placed on the bottom, inside the container, preventing water damage from the water in the aquarium. The bottom is transparent and the lights are oriented to shine through the bottom into the aquarium. The lights may be attached or sealed as described above. Lights placed on the bottom allow for lighting the aquarium without requiring an additional lighting system placed between the vivarium and the aquarium.

Lights placed external to the vivarium may be used to light the vivarium or the aquarium individually or simultaneously. The light may be placed behind the assembly, but may be placed elsewhere, provided that it is near enough to the assembly to provide heat and/or light to the assembly or its individual components. The light may hang from the vivarium or the aquarium or may be supported by an independent stand, table, or platform. An example of an external light can be found, for example, in U.S. Pat. No. 4,133,024 to Roehrick, which is hereby incorporated by reference herein in its entirety to the extent it does not contradict what is explicitly disclosed herein. An advantage of this system is that it lights the assembly without exposing the lighting to water or humidity, and allows for convenient maintenance or replacement of the lighting system. Lights in general allow for proper viewing, or to maintain an environment that mimics the day and night cycles in nature.

An electrical feature of the assembly may be connected to a timer and/or a sensor. Such features include lights, heating or cooling systems, fans or other means of condensation control, and tidal flow control mechanisms (as discussed below). Each feature may be controlled by timer and/or sensor individually, in pairs, in small groups, or as a whole. The timer and/or sensor is generally used to turn on and/or off a feature in addition to a normal on/off switch. Generally, a sensor recognizes a state that the system is in, for example, water level, light level, or temperature. When a timer is set the feature it is connected to will turn on and/or off at a particular time or after a particular duration of time. When a sensor is set the feature it is connected to will turn on and/or off when a particular state is recognized by the sensor. The ability to set a time to control when certain features of the assembly are operating may provide convenience to the user and authenticity to the environment. For example, a user may set the lights and/or the condensation control to turn on at times when viewing is most likely. When viewing is less likely, e.g. the middle of the night, the lights and condensation control may be automatically switched off, conserving energy. It may also be important for the health of the animals and the environment inside the assembly that the features not run constantly. For example, the animals may prefer periods of light and dark in order to sleep or heat during certain times may be required for cold blooded animals. The ability to set it and forget it may ensure a healthy animal environment and an increased ease of use. Additionally, timers set to work in harmony may better simulate a natural environment. For example, the lights may be set to turn on during the day and off at night, simulating the sun rise and set. The condensation control system may be set to alter the humidity similar to natural daily weather patterns. Temperature control systems may be set to raise the temperature when the lights are on and lower them when the lights are off, simulating warmer days and cooler nights. A tidal system may be timed to create a twice daily rise and fall of the water level, mimicking natural water patterns and allowing for the creation of environments like tidal pools. The closer an assembly can come to recreating the natural environment, the higher the likelihood that a partially or fully functioning ecosystem may be created.

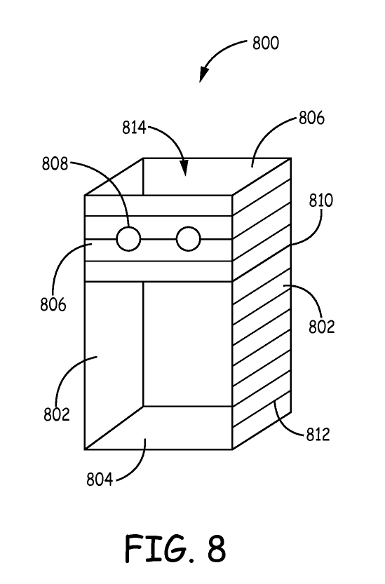

One embodiment of stand 800 is shown in FIG. 8. In FIG. 8 two side supports 802 are attached to stand base 804. Platform 810 is attached to side supports 802 some distance from the top of side supports 802. Two additional walls 806 are attached to platform 810. These walls 806 in combination with side supports 802 enclose the platform 810. Additional walls 806 contain holes 808 for access into platform area 814. Side supports and additional walls have horizontal grooves 812 etched into them.

In use, platform area 814 is filled with rocks or sand and plants. Stand 800 is placed under a hole in the bottom of the container. Animals use platform area 814 as a breeding ground and/or a means of transitioning between the aquarium and the vivarium.

In general, a stand comprises a stand base, one or more supports that extend from the bottom of the aquarium toward the container and a platform. Stands may be made of a suitable material including, for example, foam, plastic, acrylic, or metal. The stand base, generally, is a flat surface designed to sit on the floor of an aquarium and provide stability to the stand. In some embodiments, the stand base is weighted. The support may be perpendicular to the stand base or at an angle. If multiple supports are used, the supports may be substantially parallel relative to each other, may be at angles relative to each other and not cross, or they may cross. Additionally, trusses may be used in conjunction with the supports. A support may be a plank, rod, cylinder, dome, or other suitable shape. The support should maintain the platform at a height that is sufficiently close to the bottom of the container to allow animals to move freely between the container and the aquarium. The platform may be a suitable shape, for example, circular, rectangular, square, oval, or polygonal. While the platform may be substantially flat, it may also take on a three-dimensional shape, such as a bowl or an inverted pyramid. In some embodiments, the platform is surrounded by walls, which may be independent of the support or may be an extension of it. There may be one or more holes in the walls surrounding the platform to allow water or animals to enter and exit the platform area. If the platform is three-dimensional, the holes may be in the surface of the platform itself. The holes may be sized to allow the passage of fish, amphibians, or other animals into and out of the platform area. The holes may be far enough above the platform that some water remains in the platform area if the water level is lowered, creating a tidal pool. The stand may additionally comprise grooves, steps, rungs, or ramps to allow non-swimming animals (e.g. crabs) to climb the stand. Stands may be placed in a number of locations within the aquarium, for example, in the center, along the sides, or under the hole in the bottom of the container. The walls surrounding the platform allow the user to fill the area with rocks, sand, or plants, and create a breeding ground for fish. Plants present in the platform area may provide additional assistance for animals attempting to enter or exit the aquarium. An advantage of a stand is that the stand provides a means for amphibious animals as well as terrestrial animals that fall into the aquarium to return to the vivarium. Another advantage of a stand is that the stand may also provide a breeding ground for fish. When fish breed, guppies may result. Like the fruit flies and other small insects in the vivarium, guppies may provide a long term food source for larger animals. This allows a partially or fully functioning ecosystem to be established within the aquarium.

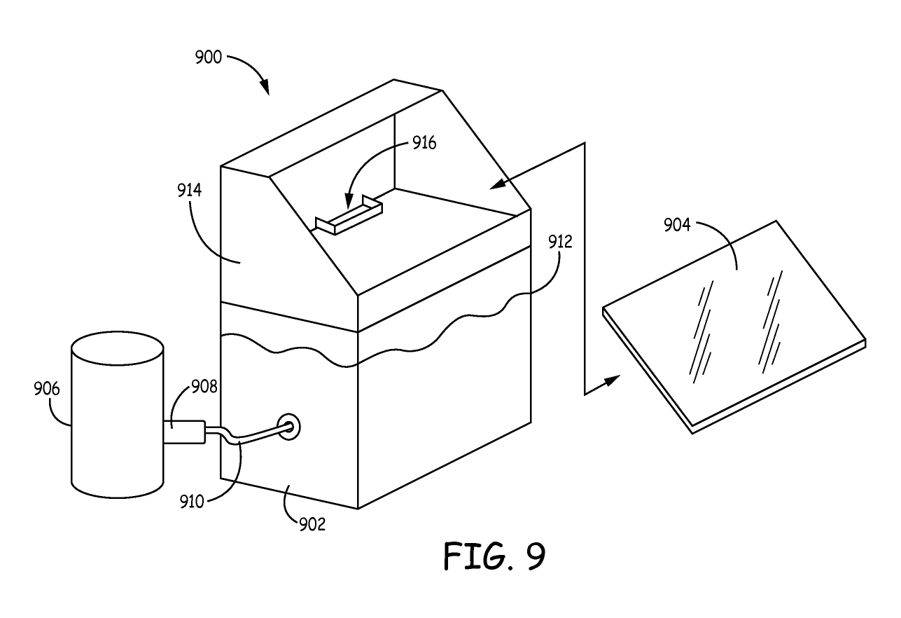

FIG. 9 depicts one embodiment of vivarium/aquarium assembly 900 with a tidal flow control mechanism. In the embodiment in FIG. 9, container 914 rests on aquarium 902 with viewing section 904 removed. Viewing section 904 is removably attached to container 914. The bottom of container 914 has hole 916 for animal access into aquarium 902. Reservoir 906 is attached to pump 908. Pump 908 and reservoir 906 combination is in fluid communication with aquarium 902 by means of hose 910.

In use, pump 908 pumps water out of aquarium 902, through hose 910 into reservoir 906 to reduce water level 912. Pump 908 pumps water into aquarium 902, through hose 910 out of reservoir 906 to increase water level 912. These processes are repeated cyclically, simulating the rising and falling tide.

A tidal flow control mechanism comprises a set of parts necessary to raise or lower the water level in the aquarium. In general, this will involve one or more pumps and hoses in addition to a reservoir and a means for turning the features of the tidal flow control mechanism on and off.

A pump may be a mechanically or electrically driven pump. The pump may be reversible in direction, i.e. it can pump the water both into and out of the aquarium, or may only pump water in one direction. In embodiments where a reversible pump is used, a single pump alternates between adding water to and removing water from an aquarium. In some embodiments where a single direction pump is used a second pump moves water in the other direction. In other embodiments, a single direction pump is used in conjunction with a drainage port or water source. The drainage port or water source may be allowed to run continuously, or may be opened and closed periodically or cyclically, as desired. The water source or drainage ports may be controlled mechanically or electrically. If they are allowed to run continuously, the pump may add or remove water more quickly than the opposing feature. In some embodiments, a pump is not required. Raising and lowering the water level is dependent instead on adding and removing water using water sources and drainage ports, as described above.

If the preservation and reuse of water is desired, a reservoir may be used in the tidal flow control mechanism. The reservoir may be sized to hold just enough water to raise and lower the water level, to hold the same amount of water as the aquarium, or to hold more water than the aquarium. The reservoir may be a suitable shape and made of a material suitable for the storage of water. Suitable materials include plastic, fiberglass, concrete, stone, and steel. Water from the reservoir may be used to raise the water level in the aquarium. When the water level in the aquarium is lowered, the excess water may be stored in the reservoir. The reservoir may be filled as necessary by the user, for example in the case of initial set up or changing the water. If water is required in the reservoir beyond the water provided by the aquarium, the water may be added by hand or the reservoir may be connected to water source. The water source may be controlled manually or electronically through switches, levers, spigots, timers, or sensors.

While the pump or reservoir may be attached directly to the aquarium, reasons of aesthetics or convenience may make it desirable for a tidal flow control mechanism to employ hoses. The hoses may be made of a suitable material for transporting water, for example, rubber, plastic, silicone, nylon, Teflon, or corrugated metal. Hoses may be used to connect various features of the tidal flow control mechanism to the aquarium and to provide a passage for water between the features. Alternatively, the tidal flow control mechanism may employ pipes. Pipe may be made of a suitable material for transporting water including, for example, PVC, plastic, metal, ceramic, or fiberglass.

To prevent animals, plants, rocks, sand, or other objects inside the aquarium from being removed from the aquarium and possibly clogging the tidal flow control mechanism, filters or other similar structures may be used to prevent larger items from entering the tidal flow control mechanism. Filters are discussed in greater detail above.

To create tidal patterns or to prevent an overflow or drainage of the aquarium, a direction control for the flow of the water may be provided. The direction control may be mechanical or electrical in nature. The control may create a tidal pattern, may alter the flow rate, or may act as an off switch for a component of the system, requiring the intervention of the user to turn the feature on. The direction control may employ sensors or timers. In one embodiment the user turns on the tidal flow control mechanism which raises and/or lowers the water. The tidal system is then turned off by a timer or when the water reaches the desired level and sets off a sensor in the aquarium or in the reservoir. The tidal flow control mechanism may also be mechanically turned off through a series of floats similar to the functionality of a toilet. In another embodiment the tidal flow control mechanism turns both on and off automatically. This may be accomplished through electrical means including sensors, timers, and switches, through mechanical means such as floats, levers, and gravity, or through a combination of electrical or mechanical means.

The rate of flow of the water into and out of the aquarium depends on the system employed for controlling the water level as well as the desired use. For example, if a tidal cycle is desired the flow rate in and out is approximately equal and is fast enough to raise and lower the water level the desired amount within a twelve hour time frame.

By using a tidal flow control mechanism, an environment can be established that mimics the natural environment of the animals in the aquarium. This may allow for proper feeding and breeding patterns as well as the establishment of micro-ecosystems, such as tidal pools. This may contribute to the health of the animals and improve the likelihood that a partially or fully functioning ecosystem may be established in the vivarium/aquarium assembly.

### FURTHER DESCRIPTION OF THE INVENTION

A vivarium system for use with an aquarium to allow an animal to readily move between a water environment and an earth environment, comprising: a closed container that communicates with ambient air through a filtered opening that comprises a filter, with the container comprising a bottom planar member adapted to fit on top of an aquarium; wherein the bottom planar member further comprises a hole providing animal access to an aquarium under the container when the container is positioned over an aquarium. The vivarium system described above wherein the filter has a pore size of no more than about 2 mm. The vivarium system described above wherein the container further comprises a viewing surface and an active condensation control system and/or a passive condensation control system, wherein the condensation control system controls condensation levels on the viewing surface. The vivarium system described above comprising the active condensation control system. The vivarium system described above wherein the active condensation control system comprises a fan to actively exchange ambient air through the filtered opening. The vivarium system described above comprising the passive condensation control system. The vivarium system described above wherein the passive condensation control system provides for a diffusion of ambient air into the container. The vivarium system described above wherein the bottom planar member further comprises an underside that is free of projections. The vivarium system described above wherein the planar member further comprises a light. The vivarium system described above wherein the light comprises a light emitting diode. The vivarium system described above wherein the bottom planar member further comprises an optically transparent material, and wherein the light shines through the optically transparent material. The vivarium system described above wherein the container further comprises one or more resealable openings. The vivarium system described above wherein the container comprises a side member comprising a viewing section, with the viewing section being optically transparent. The vivarium system described above wherein the side member is connected to the bottom, and wherein the side member comprises a diagonal portion disposed at an angle relative to the bottom, with the angle formed between the bottom and the diagonal portion being between about 10 degrees and about 80 degrees, wherein the diagonal portion comprises a viewing section, with the viewing section being optically transparent. The vivarium system described above wherein the viewing section is removably joined to the container. The vivarium system described above wherein the viewing section is disposable. The vivarium system described above wherein the transparent viewing section comprises transparent plastic. The vivarium system described above with the container comprising the bottom planar member, a top, and at least one side member, with the at least one side member being joined to the bottom planar member and with the top being permanently or reversibly attached to the at least one side. The vivarium system described above having four sides that define a polygon. The vivarium system described above wherein the at least one side member is a front side that comprises a portion perpendicular to the bottom planar member and a diagonal portion disposed at an angle relative to the bottom, with the angle formed between the bottom and the diagonal portion being between about 10 degrees and about 80 degrees. The vivarium system described above wherein the diagonal portion is sealingly and reversibly fastenable to the container and comprises a viewing section. The vivarium system described above having one side member, with the side member being oval or circular. The vivarium system described above with the bottom planar member comprising at least one flange for receiving an aquarium, with the aquarium being at least partially nested within the flange when the vivarium is placed on the aquarium. The vivarium system described above wherein the container further comprises a recess. The vivarium system described above wherein the bottom planar member further comprises inner edges that define the hole and a plurality of short barriers attached to the inner edges protruding into the container. The vivarium system described above further comprising a removable feeding tray and a tray opening in the container, with the removable feeding tray fitting inside the tray opening, wherein the removable feeding tray has an open position and a closed position, with the tray opening being sealed when the removable feeding tray is in the closed position. The vivarium system described above wherein the removable feeding tray is a box without a top. The vivarium system described above further comprising a tidal flow control mechanism that cyclically raises and lowers the depth of water in an aquarium associated with the vivarium. The vivarium system described above further comprising a stand for placement in an aquarium. The vivarium system described above wherein the stand comprises a platform and at least one platform wall that encircles the upper platform. The vivarium system described above wherein the stand further comprises notches. The vivarium system described above wherein the platform walls comprise an opening.

A method for using a vivarium system the method comprising placing a closed container on an aquarium, wherein the container comprises a bottom planar member adapted to fit on the aquarium and rests on the aquarium; wherein the closed container communicates with ambient air through a filtered opening that comprises a filter with a pore size of no more than about 2 mm; and wherein the bottom planar member further comprises a hole providing animal access to the aquarium. The method described above further comprising placing a stand in the aquarium at least partially under the hole in the bottom planar member of the closed container. The method described above wherein the closed container further comprises a viewing surface, an active condensation control system and/or a passive condensation control system, and a light; wherein the active condensation control system and/or a passive condensation control system controls condensation levels on the viewing surface; wherein the bottom planar member further comprises an optically transparent material; and wherein the light shines through the optically transparent material with the light oriented to shine light into the aquarium. The method described above wherein the active condensation control system and/or the light is connected to a timer and/or sensor. The method described in the third sentence of this paragraph wherein the system further comprises water in the aquarium with a tidal flow control mechanism that cyclically raises and lowers the depth of water in the aquarium. The method described above wherein the active condensation control system and/or passive condensation control system, the light, the tidal flow control mechanism, or a combination thereof is connected to a timer and/or sensor. The method described above wherein the timer and/or sensor is set to turn on and/or off a feature at a given time. The method described above wherein the timer and/or sensor is connected to the light and wherein the timer and/or sensor is set to turn on once in a 24 hour period and to turn off once in a 24 hour period. The described above wherein the timer and/or sensor is connected to the tidal flow control mechanism and wherein the timer and/or sensor is set to control the tidal flow mechanism to raise and lower the depth of water in the aquarium twice in a 24 hour period.

1. A vivarium system for use with an aquarium to allow an animal to readily move between a water environment and an earth environment, comprising:
a closed container that communicates with ambient air through a filtered opening that comprises a filter, with the container comprising a bottom planar member adapted to fit on top of an aquarium;
wherein the bottom planar member further comprises a hole providing animal access to an aquarium under the container when the container is positioned over an aquarium.

2. The vivarium system of claim 1 wherein the filter has a pore size of no more than about 2 mm.

3. The vivarium system of claim 1 wherein the container further comprises a viewing surface and an active condensation control system and/or a passive condensation control system, wherein the condensation control system controls condensation levels on the viewing surface.

4. The vivarium system of claim 3 comprising the active condensation control system.

5. The vivarium system of claim 4 wherein the active condensation control system comprises a fan to actively exchange ambient air through the filtered opening.

6. The vivarium system of claim 3 comprising the passive condensation control system.

7. The vivarium system of claim 6 wherein the passive condensation control system provides for a diffusion of ambient air into the container.

8. The vivarium system of claim 1 wherein the bottom planar member further comprises an underside that is free of projections.

9. The vivarium system of claim 1 wherein the bottom planar member further comprises a light.

10. The vivarium system of claim 9 wherein the bottom planar member further comprises an optically transparent material, and wherein the light shines through the optically transparent material.

11. The vivarium system of claim 1 wherein the container further comprises one or more resealable openings.

12. The vivarium system of claim 1 wherein the container comprises a side member comprising a viewing section, with the viewing section being optically transparent, wherein the side member is connected to the bottom, and wherein the side member comprises a diagonal portion disposed at an angle relative to the bottom, with the angle formed between the bottom and the diagonal portion being between about 10 degrees and about 80 degrees, wherein the diagonal portion comprises a viewing section, with the viewing section being optically transparent.

13. The vivarium system of claim 1 wherein the container comprises a side member comprising a viewing section, with the viewing section being optically transparent and wherein the viewing section is removable joined to the container.

14. The vivarium system of claim 1 with the container comprising the bottom planar member, a top, and at least one side member, with the at least one side member being joined to the bottom planar member and with the top being permanently or reversibly attached to the at least one side.

15. The vivarium system of claim 15 having four sides that define a polygon.

16. The vivarium system of claim 1 wherein the container further comprises a recess.

17. The vivarium system of claim 1 wherein the bottom planar member further comprises inner edges that define the hole and a plurality of short barriers attached to the inner edges protruding into the container.

18. The vivarium system of claim 1 further comprising a removable feeding tray and a tray opening in the container, with the removable feeding tray fitting inside the tray opening, wherein the removable feeding tray has an open position and a closed position, with the tray opening being sealed when the removable feeding tray is in the closed position.

19. A method for using a vivarium system the method comprising placing a closed container on an aquarium,
wherein the container comprises a bottom planar member adapted to fit on the aquarium and rests on the aquarium;
wherein the closed container communicates with ambient air through a filtered opening that comprises a filter; and
wherein the bottom planar member further comprises a hole providing animal access to the aquarium.

20. The method of claim 19 wherein the closed container further comprises a viewing surface, an active condensation control system and/or a passive condensation control system, and a light;
wherein the active condensation control system and/or a passive condensation control system controls condensation levels on the viewing surface;
wherein the bottom planar member further comprises an optically transparent material; and
wherein the light shines through the optically transparent material with the light oriented to shine light into the aquarium.
